(19) United States
(12) Patent Application Publication
(10) Pub. No.: US 2013/0208477 A1
(43) Pub. Date: Aug. 15, 2013

(54) EASILY COLLAPSIBLE LED BULB

(71) Applicant: Robert WANG, Luch (TW)

(72) Inventor: Robert WANG, Luch (TW)

(21) Appl. No.: 13/370,783

(22) Filed: Feb. 10, 2012

(51) Int. Cl. F21V 21/14

(52) U.S. Cl. 362/249.04

(57) ABSTRACT

An easily collapsible LED bulb mainly includes a lamp base and a lighting module. The lamp base has plural combining holes respectively engaged with plural fixing members of the lighting module, so as to fix the lighting module on the lamp base. With LEDs deployed on the lighting module and with durable pricy components, such as a power adapter etc, installed in the lamp base and electrically connected with the LEDs, it's just necessary to replace the lighting module in case of damage of the LEDs only, without necessity of discarding the whole LED bulb. So the LED bulb of the invention is genuinely eco-friendly and economic.

### BACKGROUND OF THE INVENTION

1. Field of the Invention

This invention relates to an easily collapsible LED bulb.

2. Description of the Prior Art

As LED (Light-Emitting Diode) has characteristics of long service life and low electricity consumption etc, it has been popularly developed as light source for so-called LED bulbs used to replace incandescent bulbs and fluorescent bulbs. And different from the incandescent bulbs and the fluorescent bulbs, the conventional LED bulbs are driven by direct current, so they need to be installed with power adapters and driving circuit modules to convert AC into DC so as to light up LED.

Usually, for the sake of manufacturing quickly and lowering cost, the power adapter and the driving circuit module are fixed together solidly with other LED devices on a bulb base. However, it's not eco-friendly as the whole LED bulb has to be cast aside if any one of its components is broken down and impossible to be replaced. Moreover, although the power adapter and the driving circuit module are comparatively pricy, they are uneasy to get damaged. In other words, it is LED itself that is comparatively apt to break down. Therefore, if the power adapter and the driving circuit module have to be thrown away together with the LED in case of merely a damage of LED, the LED bulbs have a high cost far beyond that of the incandescent bulbs and fluorescent bulbs, not beneficial for their popularity.

### SUMMARY OF THE INVENTION

The object of this invention is to offer an easily collapsible LED bulb with a lighting module that can be easily disassembled by users.

The main characteristics of the invention are a lamp base and a lighting module. The lamp base is provided with plural combining holes and a first connector, with each combining hole having a broad portion and a slender portion extended outward from the broad portion. The slender portion possesses a width narrower than that of the broad portion. The lighting module is installed in the lamp base, further provided with a lamp hood, at least a flexible member, a base board and plural fixing members. The lamp hood is provided with plural first engaging members corresponding to the combining holes of the lamp base. The flexible member is deposited at one side of the first engaging member of the lamp hood. The base board is elastically pressed by the flexible members, provided with plural LEDs electrically connected with a second connector that is connected with the first connector of the lamp base. And bored in the base board to correspond to each of the first engaging member is a through hole. The fixing members are inserted in the through holes respectively, with one end formed as a second engaging member to fixedly engage with the first engaging member, and with another end extended out of the through hole to expansively form as a head. The head is inserted through the broad portion of the combining hole and moved to be restricted in the slender portion so as to make the lighting module fixed on the lamp base. By the time, the base board is elastically squeezed by the flexible members to tightly rest on the lamp base. By means of the fixing members associated with the combining holes, users can conveniently remove the lighting module from the lamp base that is installed with a pricy and durable power adapter and a driving circuit module etc. In other words, it is just necessary to replace the lighting module with a new one in case of merely damage of LEDs, without necessity to discard the whole easily collapsible LED bulb, really eco-friendly and economic.

### BRIEF DESCRIPTION OF DRAWINGS

This invention is better understood by referring to the accompanying drawings, wherein:

FIG. 1 is an exploded perspective view of a preferred embodiment of an easily collapsible LED bulb in the present invention;

FIG. 2 is an exploded perspective view of a lighting module of the preferred embodiment of an easily collapsible LED bulb in the present invention;

FIG. 3 is a partial magnified cross-sectional view of the lighting module of the preferred embodiment of an easily collapsible LED bulb in the present invention;

FIG. 4 is a partial top view of the present invention, showing how a head of a fixing device is moved in a combining hole; and

FIG. 5 is a partial magnified cross-sectional view of the preferred embodiment of an easily collapsible LED bulb in the present invention.

### DETAILED DESCRIPTION OF THE PREFERRED EMBODIMENT

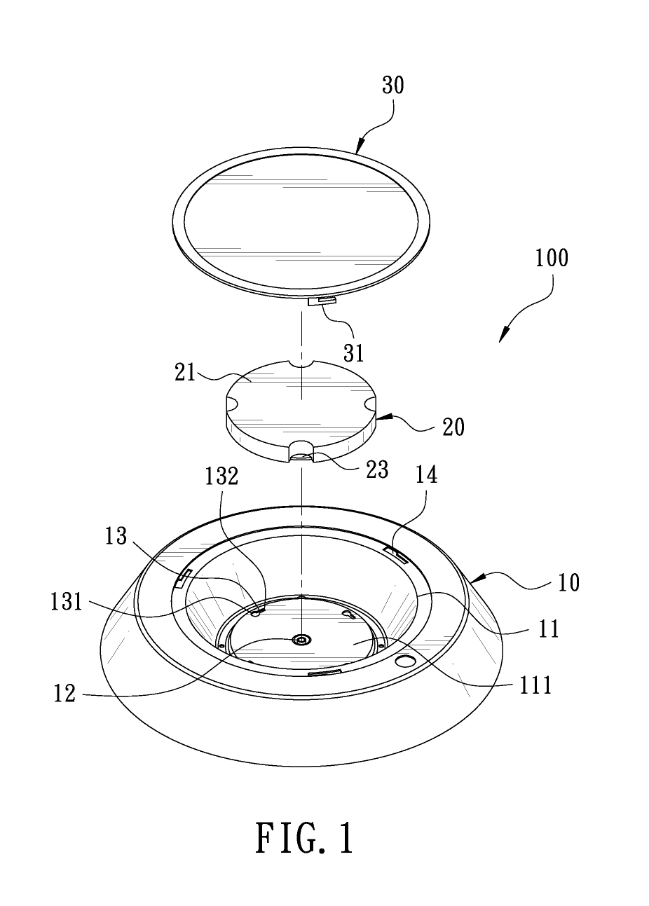

As shown in FIGS. 1-3, a preferred embodiment of an easily collapsible LED bulb 100 in the present invention is applicable as ceiling lamps, consisting of a lamp base 10, a lighting module 20 and a transparent covering 30. In addition, the easily collapsible LED bulb 100 of the present invention can be properly designed for being used as ceiling lamps, recessed lamps, light bulbs and light tubes etc, but not limited.

The lamp base 10 is made of metal, provided with an accommodating chamber 11 formed in the center with a bottom 111, a first connector 12 located in the center of the bottom 111 to output power, plural combining holes 13 bored outward around the first connector 12 in the bottom 111, and plural fixing holes 14 bored around the upper edge of the accommodating chamber 11. Each combining hole 13 has a broad portion 131 and a slender portion 132 extended outward from the broad portion 131. In this embodiment, the slender portion 132 is extended outward from the broad portion 131, with the first connector 12 utilized as a center. In addition, bored around the upper circumference of the accommodating chamber 11 are plural restricting holes 14.

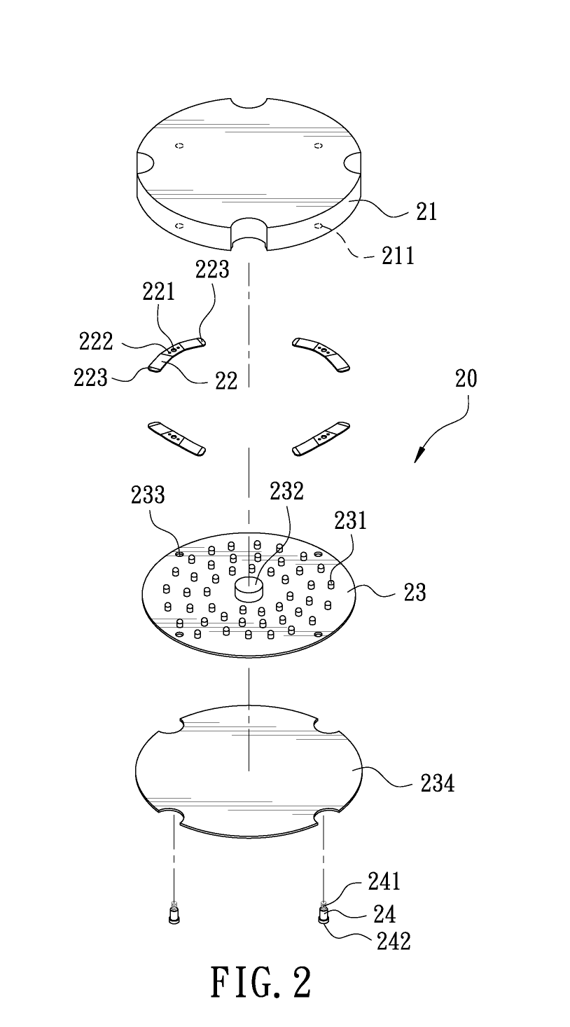

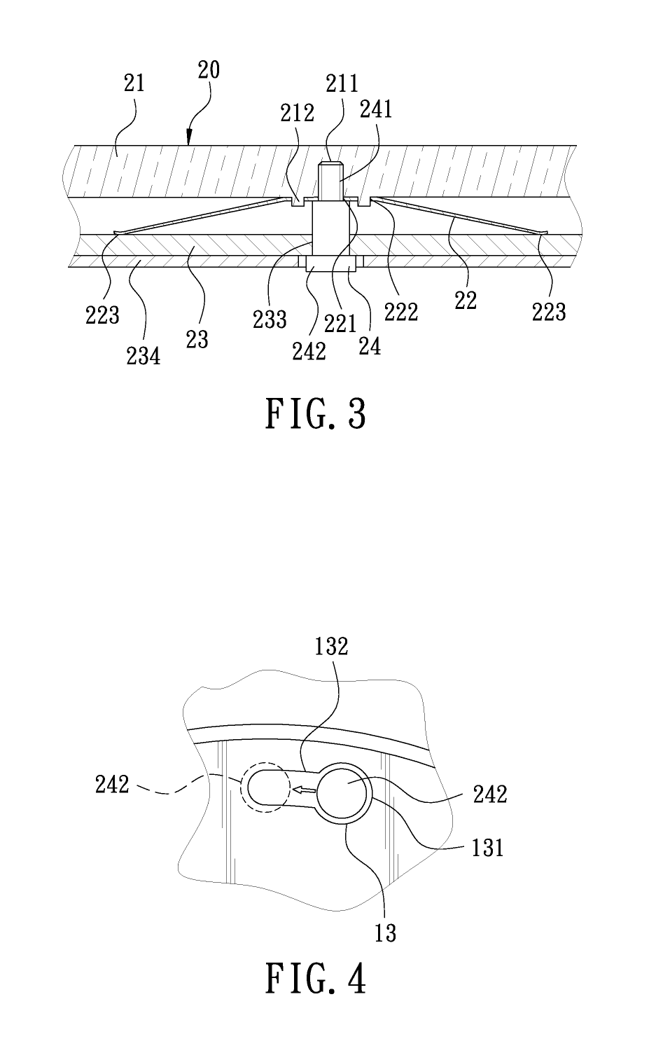

The lighting module 20 is installed in the accommodating chamber 11 of the lamp base 10, provided with a lamp hood 21, at least a flexible member 22, a base board 23 and plural fixing devices 24. The above components are to be described with reference to FIGS. 2 and 3.

The lamp hood 21 is provided with plural first engaging members 211 corresponding to the combining holes 13 of the lamp base 10, and at least a positioning bar 212 located near each of the first engaging members 211. In this embodiment, the first engaging members 211 are threaded holes, with two sides of each first engaging member 211 respectively having one positioning bar 212.

The flexible member 22 is deposited at one side of the first engaging member 211. In this embodiment, each first engaging member 211 of the lighting module 20 is engaged with one flexible member 22, which is formed as a plate spring. The flexible member 22 is provided with a through hole 221 bored in the center to correspond to the first engaging member 211, and two positioning holes 222 correspondingly inserted in the positioning bars 212 to fix the flexible member 22 under the lamp hood 21. Moreover, the flexible member 22 has two ends flatly curved outward to form as leaning tips 223.

The base board 23 is elastically pressed by the flexible members 22, provided with plural LEDs 231 deployed like a vortex, a second connector 232 connected with the first connector 12 of the lamp base 10 to electrify the LEDs 231, a through hole 233 corresponding to each first engaging member 211, and a heat disperser 234 installed at one side opposite to the lamp hood 21.

The fixing members 24 are respectively inserted in the through holes 233, with one end formed as a second engaging member 241 to fixedly engage with the first engaging member 211. In the embodiment, the second engaging member 241 is a male-threaded bar. And the fixing members 24 have another end extended out of the through hole 233 to expansively form as a head 242.

The easily collapsible LED bulb 100 is provided with a transparent covering 30, which has plural locking projections 31 built on the circumference to correspondingly interlock with the restricting holes 14, so that the transparent covering 30 can be fixed on the lamp base 10 to position outside the accommodating chamber 11.

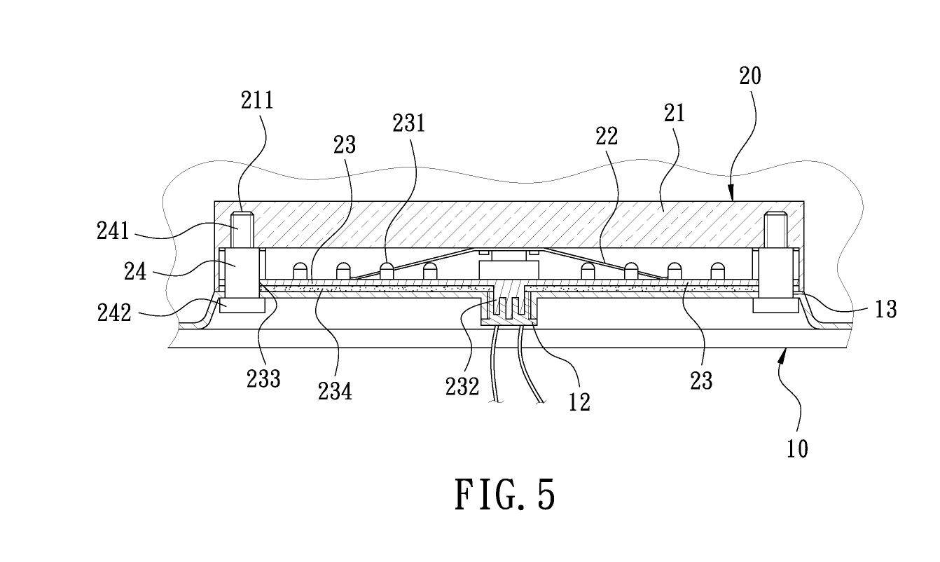

FIGS. 4 and 5 show how to assemble and disassemble the easily collapsible LED bulb 100 of the invention. In assembling, the lighting module 20 is first fixed on the lamp base 10, with the heads 242 of the fixing members 24 inserted through the broad portions 131 of the combining holes 13; next, the lighting module 20 is turned around to enable the heads 242 to move to be restricted in the slender portions 132, making the lighting module 20 fixed on the lamp base 10; then the first connector 12 is connected with the second connector 232 so as to drive LED lit up. On the contrary, when the lighting module 20 is turned around reversely to enable the heads 242 of the fixing members 24 to move to the broad portion 131, it can be removed from the lamp base 10, with the power adapter and the driving circuit module that are comparatively pricy and durable installed in the lamp base 10 and electrically connected with the first connector 12. In other words, it is just necessary to replace the lighting module 20 with a new one in case of merely damage of LEDs 231 of the base board 23, without necessity of discarding the whole easily collapsible LED bulb 100. So the invention is really eco-friendly and economic.

It should be noted that as the flexible members 22 are installed between the lamp hood 21 and the base board 23, enabling the leaning portions 223 of the flexible members 22 to elastically rest on the lamp base 10 so that the heat disperser 234 can tightly contact with the lamp base 10, heat generated by the LEDs 231 can be effectively conducted to the lamp base 10 to disperse into the surrounding air, able to make the LEDs 231 operate stably without need to extra install a heat-dispersing module.

Moreover, with the LEDs 231 deployed as a vortex to make them aligned regularly, a user can easily control the number of the LEDs 231 electrified to obtain brightness required.

While the preferred embodiment of the invention has been described above, it will be recognized and understood that various modifications may be made therein and the appended claims are intended to cover all such modifications that may fall within the spirit and scope of the invention.

What is claimed is:

1. An easily collapsible LED bulb comprising:
a lamp base provided with plural combining holes respectively having a broad portion and a slender portion extended outward from said broad portion, said slender portion having a width smaller than that of the broad portion, said lamp base further provided with a first connector;
a lighting module installed in said lamp base:
a lamp hood provided with plural first engaging members corresponding to said combining holes of said lamp base;
at least a flexible member deposited at one side of said first engaging member;
a base board elastically pressed by said flexible member and provided with plural LEDs electrically connected with a second connector connected with said first connector of said lamp base, said base board further provided with plural through holes corresponding to said first engaging members respectively; and
plural fixing members respectively inserted in said through holes of said base board and having one end formed as a second engaging member to fixedly engage with said first engaging member, said fixing members having another end extended out of said through hole to expansively form as a head able to pass through said broad portion of said combining hole and move to be restricted in said slender portion so that said lighting module is fixed on said lamp base with said base board elastically pressed by said flexible device to rest on said lamp base.

2. The easily collapsible LED bulb as claimed in claim 1, wherein said first engaging member is formed as a threaded hole and said second engaging member is a male-threaded bar.

3. The easily collapsible LED bulb as claimed in claim 1, wherein said lighting module is provided with a flexible member corresponding to each first engaging member, each said flexible member bored with a through hole for said second engaging member of said fixing member to pass through and engage with said first engaging member.

4. The easily collapsible LED bulb as claimed in claim 3, wherein said lamp hood is provided with at least a positioning bar located near each of said first engaging member to plug in a corresponding positioning hole bored in said flexible member.

5. The easily collapsible LED bulb as claimed in claim 1, wherein said flexible member is a plate spring with two ends flatly curved outward to form as leaning portions.

6. The easily collapsible LED bulb as claimed in claim 1, wherein said base board is further provided with a heat disperser installed at one side opposite to said lamp hood.

7. The easily collapsible LED bulb as claimed in claim 1, wherein said LEDs are deployed as a vortex on said base board.
